(19) United States
(12) Patent Application Publication
(10) Pub. No.: US 2003/0193384 A1
(43) Pub. Date: Oct. 16, 2003

(54) Square sleeve in combination with a drum core for electrical appliance

(76) Inventor: I-Wen Yang, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/118,976

(22) Filed: Apr. 10, 2002

(51) Int. Cl. H01F 27/06

(52) U.S. Cl. 336/65

(57) ABSTRACT

A square sleeve is made of a magnetic material and has a receiving area defined therein. At least two contacting portions are formed on a bottom face of the square sleeve and on opposite sides of the receiving area. The drum core is received in the receiving area and has a coil winding area for winding a coil having two distal ends which are electrically connected to the at least two contacting portions.

### BACKGROUND OF THE INVENTION

1. Field of the Invention

The present invention relates to a combination of a square sleeve and a drum core, and more particularly to a combination of a square sleeve and a drum core for electrical appliance. The drum core is mounted in the receiving area in the square sleeve so as to eliminate the unnecessary process to reduce cost and enhance the inductance of the combination.

2. Description of Related Art

With reference to FIG. 6, a conventional combination 9 of a square sleeve and a drum core is shown. The combination has a rectangular base 91 made of plastic, a magnetic ring 94 on top of the base 91, multiple metallic contacts 92 extending out of the base 91 so as to form feet 93 outside the base 91. With the feet 93, the base 91 is able to be mounted on a circuit board (not shown). A drum core 95 is provided in the magnetic ring 94 and has a coil winding area 96 defined in a mediate portion of the drum core 95 so that a coil 97 is able to be wound around the drum core 95 in the coil winding area 96. Two distal ends 971 of the coil 97 is connected to contacts 92 oppositely arranged in the base 91.

With reference to FIG. 7, a second embodiment 9A of the conventional combination of the square sleeve and the drum core is shown and has a base 91A with multiple L shaped extensions (not numbered), a magnetic ring 94A on top of the base 91A and feet 93A arranged outside the base 91A so as to mount the base 91A on a circuit board (not shown). A drum core 95A is provided in the magnetic ring 94A and has a coil winding area 96A defined in a mediate portion of the drum core 95A so that a coil 97A is able to be wound around the drum core 95A in the coil winding area 96A. Two distal ends 971A of the coil 97A is connected to feet 93A oppositely arranged in the base 91A.

The separation mounting process for the magnetic ring 94,94A increases the difficulty of manufacturing the combination. Furthermore, the feet 93,93A, although can be made directly by bending a metal plate, the additional process of dealing with them are quite troublesome and undesirable. Another drawback of the conventional combination 9, 9A is that the inductance performance is limited by the material used.

To overcome the shortcomings, the present invention intends to provide an improved combination of a square sleeve and a drum core to mitigate or obviate the aforementioned problems.

### SUMMARY OF THE INVENTION

The primary objective of the invention is to a combination of a square sleeve and a drum core for electrical appliance, e.g., cellular phone, stereo, computer, etc. The drum core is mounted in the receiving area in the square sleeve so as to eliminate the unnecessary process to reduce cost and enhance the inductance of the combination.

Another objective of the invention is to provide a combination of a square sleeve and a drum core, which is able to enhance the inductance performance and to reduce the space occupied.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the combination of a square sleeve and a drum core of the present invention;

FIG. 2 is an exploded perspective view of the combination of the present invention;

FIG. 3 is an exploded perspective view showing that coil is wound around the drum core of the present invention;

FIG. 4 is a schematic view showing the application of the combination of the present invention;

FIG. 5 is a schematic view showing the combination is mounted on a circuit board;

FIG. 6 is a perspective view of a conventional combination of a square sleeve and a drum core; and

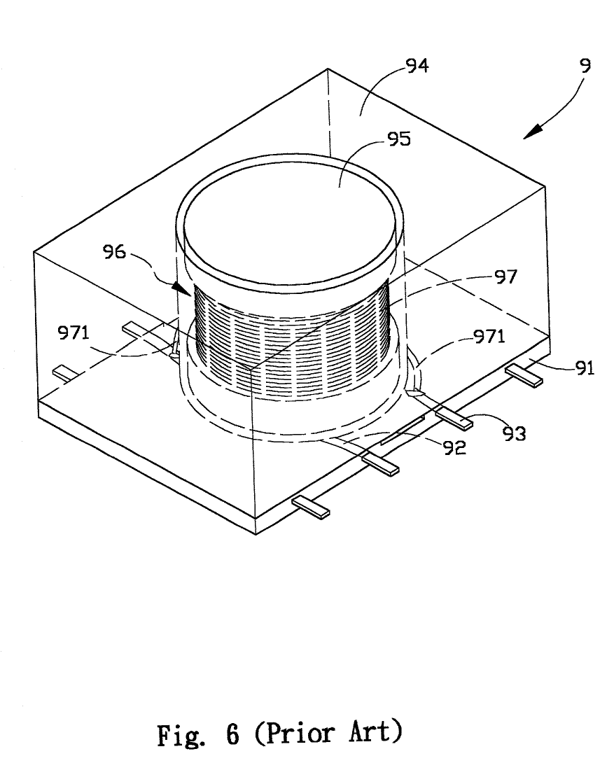

FIG. 7 is a perspective view of still a conventional combination of a square sleeve and a drum core.

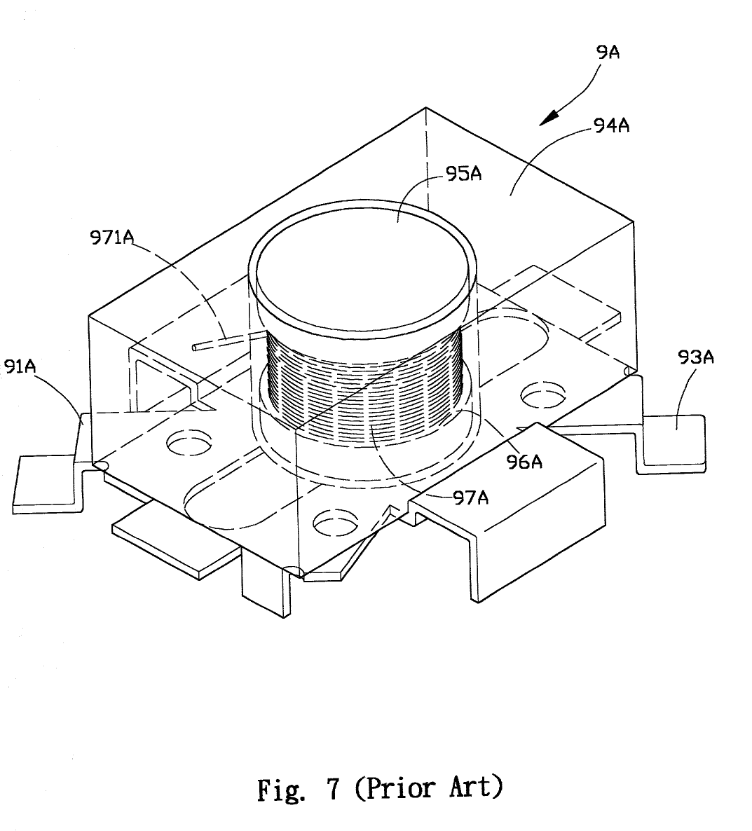

### DETAILED DESCRIPTION OF PREFERRED EMBODIMENT

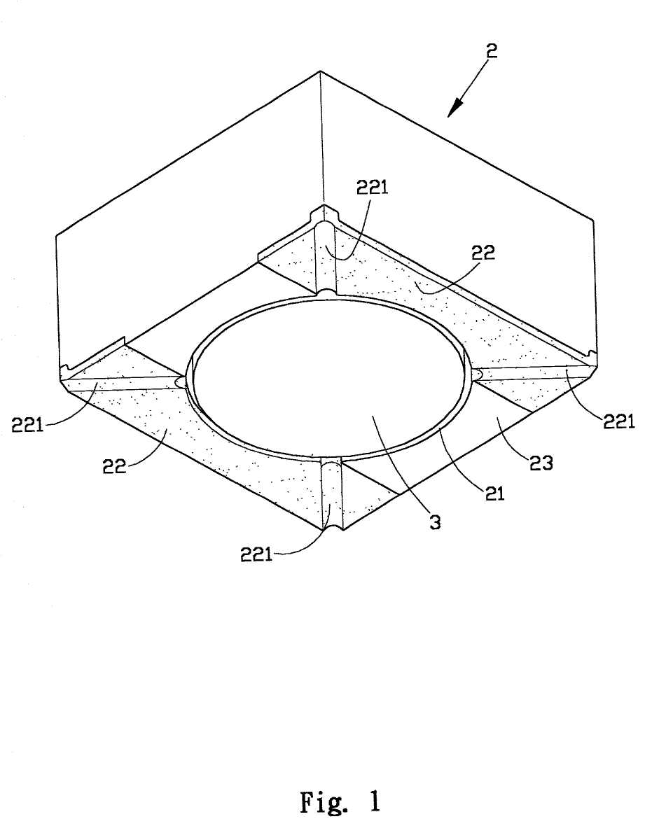

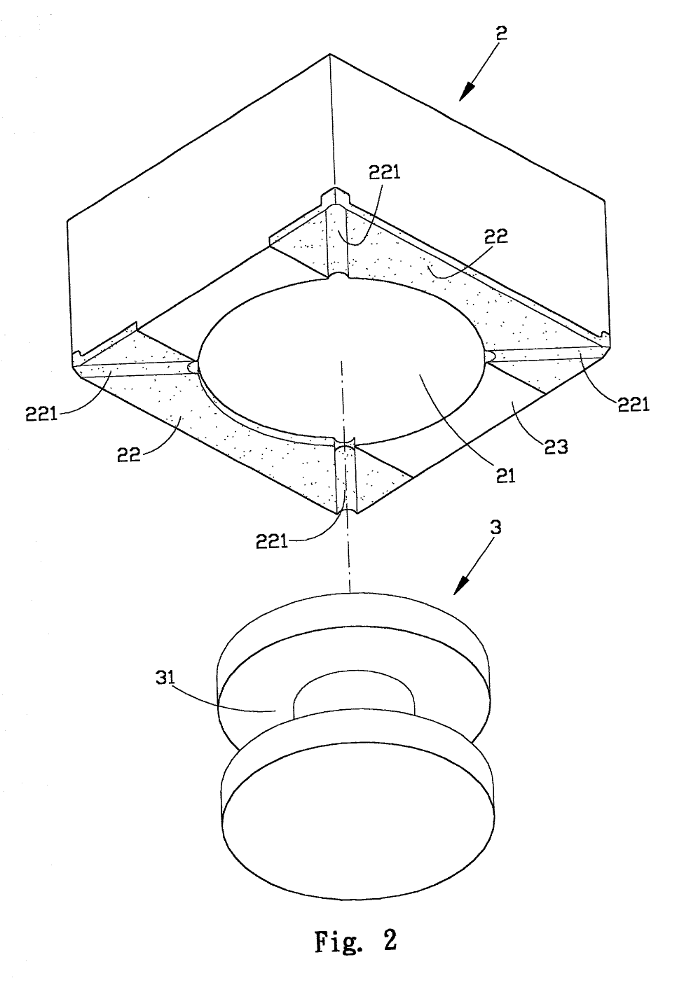

With reference to FIG. 1 and FIG. 2, the combination of a square sleeve and a drum core includes:

a square sleeve 2 which is made of a magnetic material and has a receiving area 21 defined therein, wherein in this embodiment, the receiving area 21 is a through hole;

at least two contacting portions 22 which are formed on a bottom face 23 of the square sleeve 2 and on opposite sides of the receiving area 21, wherein the at least two contacting portions 22 are formed on the bottom face 23 of the square sleeve 2 by metalized process, each of the at least two contacting portions 22 has a guiding recess 221 extending toward the receiving area 21 from a corner of the square sleeve 2; and

a drum core 3 which is received in the receiving area 21 and has a coil winding area 31.

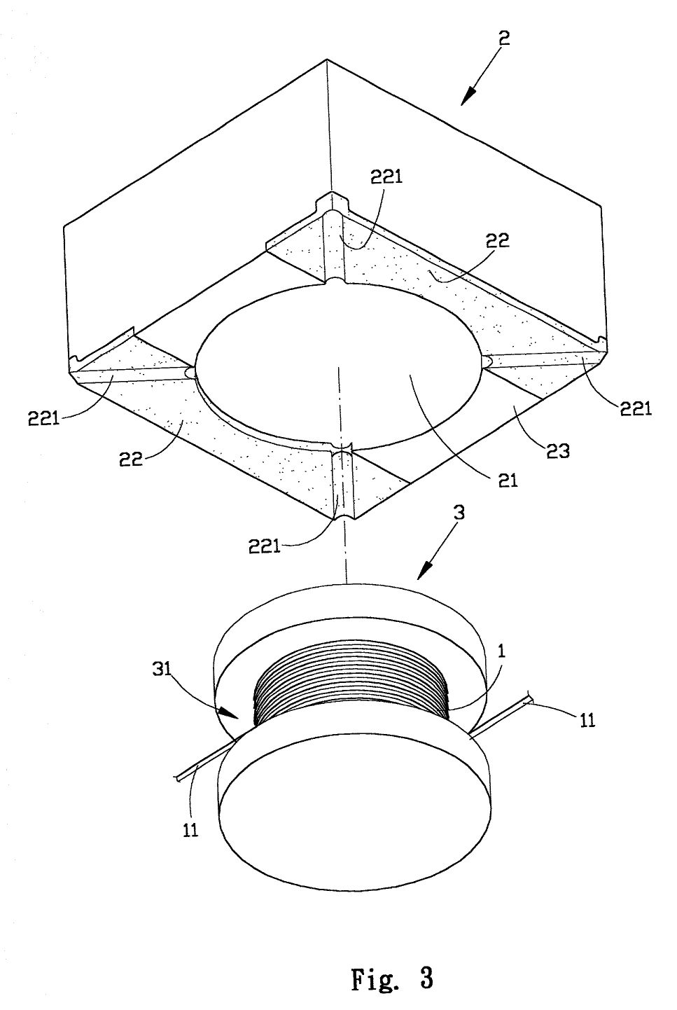

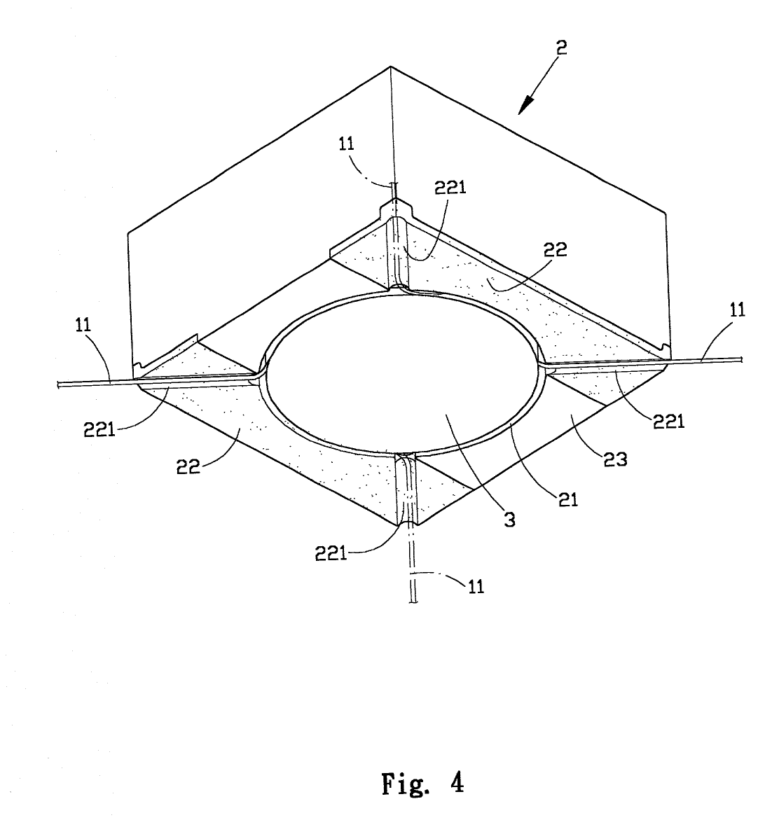

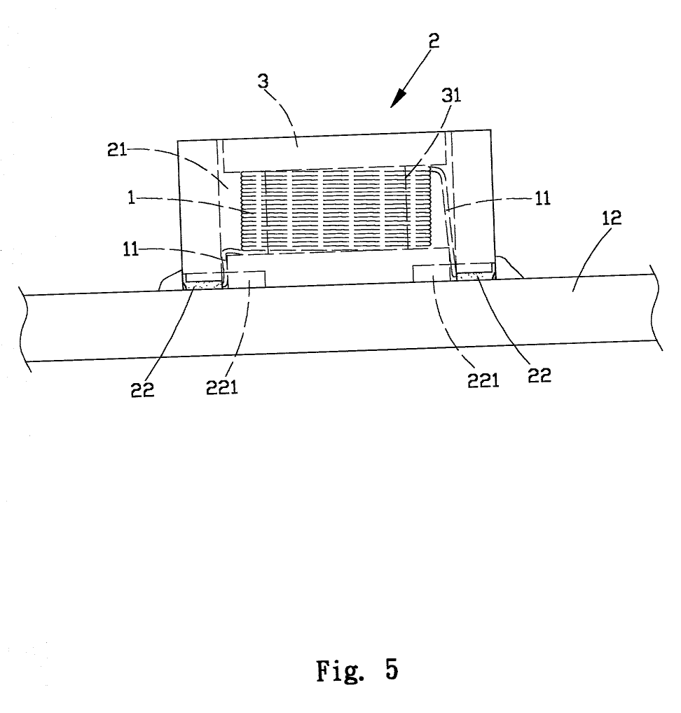

With reference to FIGS. 3 to 5, when assembly of the combination of the present invention is required, a coil 1 is wound around the coil winding area 31 and two distal ends 11 of the coil 1 are received in two opposite guiding recesses 221. Because there are four guiding recesses 221, the two distal ends 11 of the coil 1 are able to be received in either pair of two opposite guiding recesses 221 such that each one of the distal ends 11 has different directional feature so as to enhance the convenience when in assembly. Then the drum core 3 is placed in the receiving area 21. Thereafter, the two contacting portions 22 are electrically connected to a circuit board 12.

It is to be noted that the two connecting portions 22 are formed on the bottom face 23 of the square sleeve 2 and the drum core 3 is placed in the receiving area 21 so that there is no requirement to separately assemble the magnetic ring and the base as does the conventional structure. Furthermore, the dimension of the combination of the present invention is reduced so as to increase the convenience in assembly. Still, due to the material for making the square sleeve 2 being magnetic material so that after assembly, the combination is able to increase he inductance performance.

Although the foregoing description describes that there are two contacting portions 22, two additional contacting portions 22 may also be added to achieve the required objective.

In conclusion, the combination of the square sleeve and the drum core is able to reduce its dimension, which is quite useful when engaged with the circuit board, and to increase its inductance performance when mounted on a circuit board.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a combination of a square sleeve and a drum core, wherein the improvements comprise:
the square sleeve is made of a magnetic material and has a receiving area defined therein,
at least two contacting portions are formed on a bottom face of the square sleeve and on opposite sides of the receiving area; and
the drum core is received in the receiving area and has a coil winding area for winding a coil having two distal ends which are electrically connected to the at least two contacting portions.

2. The combination as claimed in claim 1, wherein each of the at least two contacting portions has at least one guiding recess extending toward the receiving area from a corner of the square sleeve.

3. The combination as claimed in claim 2, wherein the at least two contacting portions are mounted on opposite sides of the square sleeve.

4. the combination as claimed in claim 3, wherein four guiding recesses are defined in each corner of the square sleeve to extend toward the receiving area.

5. The combination as claimed in claim 1, wherein the at least two contacting portions are formed on the bottom face of the square sleeve by metalized process.

6. The combination as claimed in claim 1, wherein the receiving area is a through hole.
